(19) United States
(12) Patent Application Publication
(10) Pub. No.: US 2006/0067598 A1
(43) Pub. Date: Mar. 30, 2006

(54) Anti-rotation bearing cup retainer

(76) Inventors: William Bruce Engle, Simpsonville, SC (US); Yogendra K. Sharma, Greenville, SC (US); Donald Bradford Miller, Greer, SC (US); Chuong Huy Nguyen, Simpsonville, SC (US)

Correspondence Address: ROCKWELL AUTOMATION, INC./(FY), ATTENTION: SUSAN M. DONAHUE, 1201 SOUTH SECOND STREET, MILWAUKEE, WI, 53204, US

(21) Appl. No.: 10/955,638

(22) Filed: Sep. 30, 2004

(51) Int. Cl. F16C 33/00; F16C 33/02

(52) U.S. Cl. 384/626

(57) ABSTRACT

In accordance with one embodiment, a system and device are disclosed for preventing damage to one or more shims of a rotating machine. The system incorporates an anti-rotation spacing device that fits within a bearing bore or recess between the one or more shims and a bearing assembly. The anti-rotation spacing device prevents the rotation of the bearing assembly from damaging the one or more shims present within the recess. In an exemplary embodiment, the device comprises a generally annular structure or body and an anti-rotation feature. A method for protecting shims within a bearing bore and method of manufacturing an anti-rotation spacing device are also disclosed.

### BACKGROUND

The invention relates generally to rotating machines, such as gear reducers and electric motors. More particularly, the present invention relates to a technique for preventing damage to shims located within a bearing recess of a rotating machine.

A wide range of applications exist for rotary drive systems, including numerous aspects of industry, material handling, agriculture, and transportation, to mention just a few fields. In general, many such systems are based upon the generation of rotational motion which is transmitted to various machine elements through couplings, gear drives, transmissions, and so forth. In systems where a prime mover, such as an electric motor or an internal combustion engine, rotates at a speed other than that desired in the actual application, gear reducers or variable speed drives are typically employed to reduce or increase the speed and torque to the desired range.

The input and output elements of power transmission components must interface with one another to transmit mechanical power reliably, and to withstand loading likely to be encountered in use. Input and output in such systems are often provided by rotating shafts which may be coupled to one another via couplings, sheaves, belts, or similar techniques. In specific applications, however, it is often useful to interface a shaft within a hub designed to receive the shaft, and to transmit power either from the shaft to the hub or vice versa. By way of example, certain gear reducers are designed with an input shaft and an output hub internally coupled to one another via intermeshing gears and pinions. The machine is designed to be secured firmly to an output shaft which is inserted in the hub. A range of coupling and support configurations have been designed and are presently in use for insuring reliable power transmission in such arrangements, while offering resistance to additional loading provided by the coupling system itself.

Power transmission systems often employ bearing assemblies to support various rotating elements within these systems while allowing free rotation of the supported elements. These bearing assemblies generally include an inner ring (or bearing cone), an outer ring (or bearing cup), and a plurality of bearings disposed between the inner and outer rings. Tapered roller bearings are frequently used in such systems, but other bearings, such as ball bearings and non-tapered roller bearings, could also be employed if desired for a specific application. These bearing assemblies reduce unwanted friction by providing smooth inner and outer surfaces against which the bearings travel. A shaft or hub may be inserted through the central opening of the bearing assembly thereby allowing securing of the shaft or hub as it rotates. Such a shaft or hub may then be engaged to drive various machines, such as fans, turbines, or a wide range of other machines.

The rotation of the shaft or hub, in conjunction with the bearing assembly, typically subjects the bearing assembly to radial and thrust loads. In order to support the bearing assembly against subjected loads that induce undesirable movement, the bearing assembly is set within a housing of the power transmission system. More specifically, bearing assemblies are generally placed within a bore of the housing adapted to receive the bearing assemblies. These bores in power transmission housings, however, must generally be carefully manufactured with low tolerances to allow for proper fit of bearing assemblies within these bores. This high level of precision generally requires a greater investment in labor and equipment capable of producing such housings, resulting in a higher manufacturing cost for a power transmission system.

As an alternative to the costly, high precision manufacture of a bearing assembly and system housing, one or more shims may be employed within the bearing bore of the system housing. Shims may be placed within the bore between the housing and the outer ring of the bearing assembly to reduce the end play of the bearing assembly within the bore. Using shims in this fashion allows for greater manufacturing tolerances and reduces the precision required in manufacture of the bearing assemblies and bores which, consequently, results in a lower manufacturing cost. However, this alternative manufacturing method, while lower in initial cost, presents certain difficulties not present in the higher precision manufacturing process.

While the inner rings or bearing cones of bearing assemblies are intended to rotate in conjunction with the rotational members of a power transmission system, the outer rings and bearing cups of these assemblies may also rotate within a bearing recess. The rotational motion of the bearing cups against the shims may cause premature failure of these shims within the bore. Further, failure of a shim within a bearing recess of a machine housing may result in a portion of the shim entering the bearing assembly within the recess and causing failure of the entire assembly. Such failures result in greater expense, both in terms of the labor and materials required to repair these systems and the associated down time in which the system is inoperable. Shim damage in these systems may be avoidable by preventing rotation of the bearing cup within the bore. The rotation of the bearing cup may be prevented by providing for an interference fit of the bearing cup within the bore, but such a fit requires a higher, and more expensive, level of precision. Rotation of the bearing cup may also be eliminated by use of an adhesive product to bond the bearing cup within the bore, which again adds to the manufacturing cost of a machine. Additionally, both of these methods of preventing rotation of the bearing cup rely on binding the bearing cup to the bore surface, make future needed shimming adjustments more difficult and time-consuming.

There is, therefore, clearly a need for a more reliable and cost effective manufacturing method for producing power transmission system housings and bearing assemblies. More particularly, a need exists for a method of protecting shims within a bearing bore of a power transmission system housing that prevents premature shim failure while allowing future adjustment of the shims on an as needed basis.

### BRIEF DESCRIPTION

The present invention provides a novel system for preventing damage to one or more shims inside a rotating machine. The system makes use of a spacing device adapted to prevent damage to the one or more shims. The spacing device is positioned between the one or more shims and a bearing assembly of the rotating machine. The bearing assembly comprises an inner ring, an outer ring, and a plurality of bearings. The spacing device prevents the transmission of rotational motion of the outer ring to the shims, thus preventing damage to, and premature failure of, the shims and bearing assembly.

In accordance with one embodiment, an anti-rotation spacing device and a method of manufacturing the same device are provided. The anti-rotation spacing device comprises a generally annular structure and an anti-rotation feature, which may be a tab, a notch, or some other feature. The anti-rotation feature may work in cooperation with a complimentary surface of a bearing recess of a rotating machine to prevent the anti-rotation spacing device from rotating in the bearing recess. The device may be manufactured by stamping the device out of a sheet of metal and deburring the device.

Also provided is an exemplary method for preventing damage to shims near a bearing assembly. The method comprises forming an anti-rotation feature on a surface adjacent to a recess in the housing and placing a bearing assembly, shim, and anti-rotation spacing device within the recess. The anti-rotation spacing device is placed between the shim and bearing assembly and cooperates with an anti-rotation feature of the surface adjacent to the recess to prevent rotation of the device.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of a gear reducer in accordance with certain aspects of the present techniques;

FIG. 2 is a sectional view of the gear reducer of FIG. 1 taken generally along line 2-2;

FIG. 3 is a detail view of a portion of the sectional view of FIG. 2 showing the area generally encompassed by line 3-3;

FIG. 4 is an elevational view of an anti-rotation spacing device with features in accordance with certain aspects of the present techniques;

FIG. 5 is a detail view of a portion of the sectional view of FIG. 3 showing the area generally encompassed by line 5-5;

FIG. 6 is an exploded view of shims and an anti-rotation spacing device within a bearing recess in accordance with certain aspects of the present techniques; and

FIG. 7 is a block diagram illustrating a method for preventing premature shim failure in a rotating machine in accordance with certain aspects of the present techniques.

### DETAILED DESCRIPTION

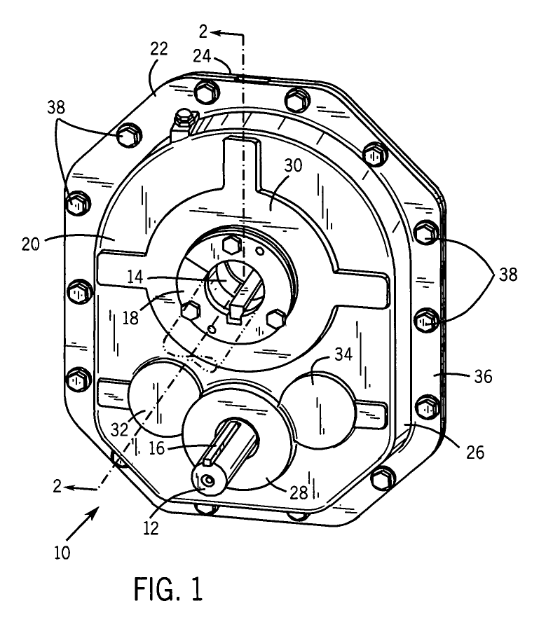

Turning now to the drawings, and referring first to FIG. 1, a two-stage gear reducer, represented generally by the reference numeral 10, is illustrated as including an input shaft 12 which will be driven in a final application, and which will transmit mechanical power to an output hub 14 as described more fully below. It should be noted that while reference is made in the present description to input and output shafts and hubs, aspects of the present invention are not intended to be limited to any particular input or output configuration. In particular, input can be made into the gear reducer via an input hub configuration, or a shaft, with output from the gear reducer being made through a hub as illustrated, or via an output shaft. Similarly, while reference is made herein to a gear reducer, the machinery described herein may be employed for increasing speeds, where desired, or simply for transmitting rotary power without changes in speed.

In the illustrated embodiment, input shaft 12 is provided with a standard key 16 for transmitting torque, while output hub 14 is provided with a taper locking coupling system 18 and a key. Again, any suitable arrangements may be made for coupling the input and output components to other machinery, including keyed shafts and hubs, splined shafts and hubs, and so forth.

In the particular application illustrated, gear reducer 10 includes a housing 20 for supporting at least the input and output rotating assemblies associated with shaft 12 and hub 14, as well as other rotating assemblies used to transmit torque between these components. As illustrated in FIG. 1, housing 20 includes a front housing half or shell 22, and a rear housing half or shell 24. The housing shells may be configured as identical structures, such that initial blanks or castings for the shells may be machined and assembled to form both the front and back shells. Each shell 22 and 24 of housing 20 includes an extending body portion 26 designed to enclose internal components of the gear reducer as described below.

Each shell 22 and 24 of housing 20 also includes a series of support structures integrally formed therein for mechanically supporting rotating assemblies. These assemblies may include input shaft 12, output hub 14, as well as additional input or output assemblies, and intermediate rotating assemblies for transmitting torque in multiple stages. In the presently illustrated embodiment, four support structures are provided on each housing shell, including an input support 28, and output support 30, a first offset support 32, and a second offset support 34. Again, the designations as input or output supports should not be interpreted as limiting the applicability of the various support locations. Input or output rotating structures may be provided at any one of the supports.

The front and rear shells of housing 20 may each be surrounded by a partial or, in the presently illustrated embodiment, a complete peripheral flange 36 for facilitating assembly of the gear reducer. In particular, the shells are secured to one another with the rotating assemblies positioned therein, via a series of fastener sets 38 extending through the peripheral flanges. Machine mounting flanges, support structures, and so forth (not shown) may include apertures which also receive certain of the fastener sets extending through the peripheral flanges of the gear reducer to support the gear reducer in given applications.

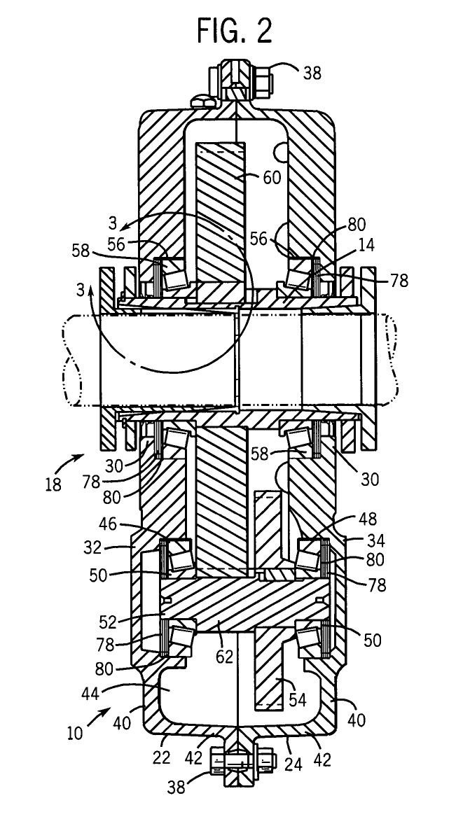

Referring now more particularly to the internal configuration of the gear reducer illustrated in FIG. 1, FIG. 2 depicts a torque-transfer path through the rotating assemblies of gear reducer 10 supported at several of the support locations described above. As shown in FIG. 2, front housing shell 22 and rear housing shell 24 may be identical structures coupled to each other through a series of fastener sets 38. The presently illustrated housing shells 22 and 24 each include a generally planar wall 40 formed integrally with a peripheral wall 42. Walls 40 and 42 of each housing shell, when assembled in the product, enclose an internal cavity 44 in which the gearing, bearings, and other components of the gear reducer are positioned.

At each rotating assembly support location, the housing shells are provided with support structures which can be machined to receive a support bearing assembly for the rotating assembly. In particular, as shown in FIG. 2, bearing supports 46 and 48 are formed in support 32 of front housing shell 22 and support 34 of rear housing shell 24, respectively, to support an intermediate rotating assembly. Bearing assemblies 50 are provided in bearing supports 46 and 48 for supporting an intermediate rotating assembly, comprising shaft 52 and gear 54 in the present illustration, in rotation. Gear 54 of the intermediate rotating assembly may transmit torque to another shaft, such as shaft 12 of FIG. 1, by intermeshing with a pinion or gear coupled to the shaft to provide an initial or first stage gear reduction.

Similarly, supports 30 of front housing shell 22 and rear housing shell 24 each include a bearing support 56 for receiving bearing assemblies 58, which support hub 14 in rotation. In turn, hub 14 may transmit torque to an attached shaft, which may be coupled to hub 14 via taper locking coupling system 18. An output gear 60 may be secured to hub 14 for rotation therewith, intermeshing with a pinion section 62 of shaft 52. Pinion section 62, in the illustrated embodiment, is formed integrally with shaft 52 adjacent to the location of gear 54 in the assembled product.

It should be noted, that while identically sized and rated bearing assemblies may be provided on either side of each rotating assembly, depending upon anticipated loading, bearing assemblies of different sizes or ratings may be provided. In particular, bearing assemblies 50 and 58 on either side of shaft 52 and hub 14, respectively, may each have a different size and rating in view of the anticipated loading of shaft 52 and hub 14. Similarly, the bearing supports formed in each support structure may be machined to different dimensions (e.g., diameters and depths) to accommodate the bearing assembly to be supported therein.

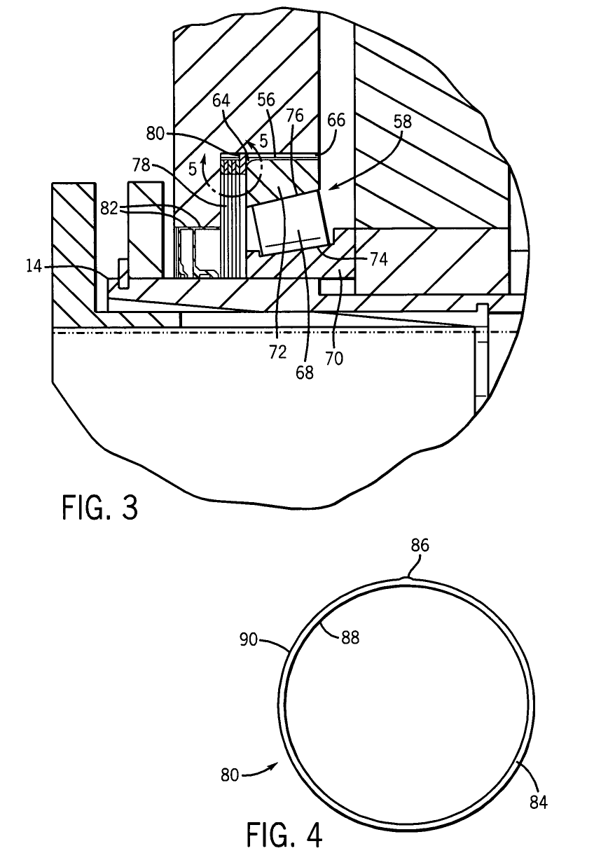

As discussed in further detail below with respect to FIGS. 3-6, one or more shims 78 and an anti-rotation spacing device 80 may be advantageously positioned within a bearing recess, such as those formed within supports 30, 32, and 34. Shims 78 and anti-rotation spacing device 80 may be used to compensate for higher manufacturing tolerances of the bores formed in housing shells 22 and 24, as well as the bearing assemblies, by reducing end play of the bearing assemblies within bearing recesses. Both the shims and the anti-rotation spacing device may have varying dimensions depending upon the intended application. For instance, in the present embodiment, the shims generally have an outer diameter of such size that permits placement within a particular bearing recess and may have widths of 0.005 inches, 0.007 inches, 0.010 inches, or 0.015 inches. Further, anti-rotation spacing device 80 may have a wider width than that of one or more of shims 78, such as a width of 0.040 inches. In the preferred embodiment, both the shims 78 and anti-rotation spacing device 80 are formed from steel. However, the shims 78 and anti-rotation spacing device 80 may be formed from any suitable material, such as a non-steel metal or a plastic.

Anti-rotation spacing device 80 is positioned between one or more shims 78 and a bearing assembly, such as bearing assemblies 50 or 58, to protect shims 78 from damage from the rotation of the bearing assembly. It should be noted that while shims 78 and anti-rotation spacing device 80 are illustrated in the present figures as being incorporated into the gear reducer 10, the present techniques are not intended to be limited to such a system. Particularly, shims 78 and anti-rotation spacing device 80 may be incorporated into a number of other devices in which bearing assemblies are employed, including electric motors.

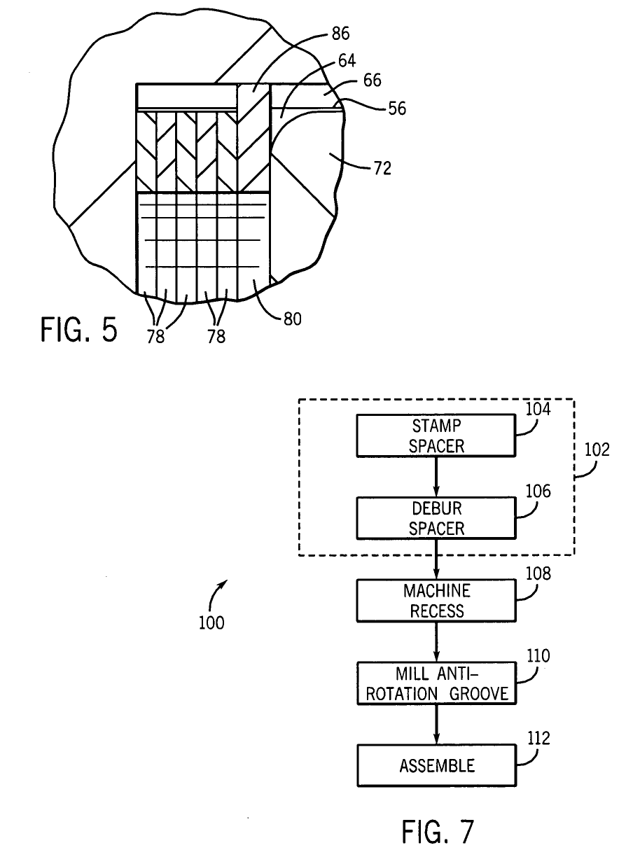

A more detailed view of a bearing assembly within gear reducer 10 is illustrated in FIG. 3. As described with respect to FIG. 2 above, bearing support 56 is adapted to receive bearing assembly 58, which, in turn, supports hub 14 in rotation. More specifically, bearing support 56 encompasses a bearing recess or bore 64 within which bearing assembly 58 is positioned. As discussed further below with respect to FIG. 5, bearing support 56 may also include a groove 66 configured to cooperate with an extended portion of anti-rotation spacing device 80 to protect one or more shims 78. In the present illustration, bearing assembly 58 includes tapered roller bearings 68, an inner ring or bearing cone 70, and an outer ring or bearing cup 72. Bearing cone 70 and bearing cup 72 provide, respectively, a smooth inner surface or race 74 and a smooth outer surface or race 76 against which tapered roller bearings 68 travel. Additionally, at each location where hub 14 extends through the shell, one or more seal assemblies 82 may be provided for retaining lubricant within the gear reducer housing and preventing the ingress of contaminants and fluids from outside the housing.

An exemplary embodiment of an anti-rotation spacing device 80 is depicted in FIG. 4. In this preferred embodiment, anti-rotation spacing device 80 comprises a generally annular body or structure 84, comprising an inner perimeter 88 and an outer perimeter 90. Also shown in the present figure is an anti-rotation feature 86. In the present illustration, anti-rotation feature 86 comprises an extended portion or tab which extends radially from the generally annular structure of the anti-rotation spacing device, thus varying the generally circular shape defined by outer perimeter 90.

It should be noted, however, that while this preferred embodiment depicts anti-rotation feature 86 as a tab that cooperates with groove 66 (see FIG. 5), the present disclosure is not limited to this form. For example, anti-rotation feature 86 may instead comprise an indentation or notch in outer perimeter 90 of device 80 configured to cooperate with a ridge protruding from the surface of a bearing recess proximate to the location of the installed spacer, such that the ridge does not extend so far as to interfere with placement of the bearing assembly within the recess. As discussed further in regard to FIGS. 3 and 5, anti-rotation feature 86 of the anti-rotation spacing device 80 cooperates with the surface of a bearing recess to prevent transmission of a rotational force from a bearing assembly to shims placed behind anti-rotation spacing device 80.

A detailed view of shims 78 and anti-rotation spacing device 80 of FIG. 3 is shown in FIG. 5. As discussed above with respect to FIG. 3, bearing support 56 encompasses a bore 64 which receives one or more shims 78, an anti-rotation spacing device 80, and a bearing assembly 58 (see FIG. 3). Shims 78 are utilized to reduce end play of bearing assembly 58. Anti-rotation spacing device 80 is interposed between shims 78 and bearing cup 72 of bearing assembly 58 to prevent damage to the shims that could otherwise be caused by the rotation of the bearing cup. As the bearing cup rotates within the bore, an anti-rotation feature 86 prevents anti-rotation spacing device 80 from rotating with the bearing cup, thereby preventing a rotational force of the bearing cup from being applied to shims 78. In the preferred embodiment presently illustrated, anti-rotation feature 86 is an extension or tab configured to fit within groove 66 of bearing support 56. While frictional force from the rotation of bearing cup 72 would ordinarily cause reciprocal rotation of anti-rotation spacing device 80, the extension formed on the spacing device 80 causes the maximum diameter of device 80 (including the extension) to be greater than the diameter of bore 64. Groove 66 is of sufficient depth to accommodate the oversized portion of the spacer, while keeping the tab within the groove, thereby physically preventing rotation of anti-rotation spacing device 80.

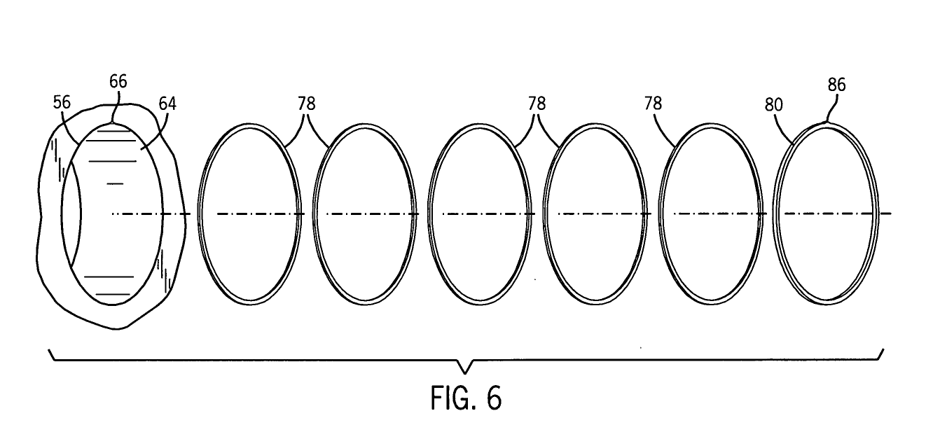

A partial exploded view of bore 64 is provided in FIG. 6. As described above, bearing support 56 encompasses bore 64 to receive one or more shims 78, anti-rotation spacing device 80, and a bearing assembly, such as bearing assembly 58 of FIG. 3. In this exemplary embodiment, the outer diameters of shims 78 are less than that of the bore, thus allowing a clearance fit of the shims with the bearing support. As discussed above, the shims may each have the same thickness, or may instead have a variety of thicknesses. Combinations of shims and of the anti-rotation spacing device 80 are thus selected to provide the desired fit of the rotating elements and bearings in the assembled structure.

After shims 78 are placed within bore 64, anti-rotation spacing device 80 is positioned in front of the shims. As discussed above, in the presently illustrated exemplary embodiment, anti-rotation feature 86 of anti-rotation spacing device 80 is a tab that causes the maximum diameter of device 80 to exceed that of the bearing bore. A groove 66 is thus formed in the bearing support to accommodate anti-rotation feature 86, while allowing cooperation with the anti-rotation feature in preventing rotation of anti-rotation spacing device 80.

An exemplary method for preventing damage to shims within a rotating machine is presented in FIG. 7. This method 100 includes a step 102 of providing a spacer, such as anti-rotation spacing device 80 of FIG. 4. In the present figure, the spacer is provided through a manufacturing process comprising steps 104 and 106 of stamping and deburring the spacer. Although the current illustration provides for stamping the spacer, those skilled in the art will recognize that the spacer may also be formed from some other manufacturing process, such as machining the spacer, for example. The spacer may be formed of numerous materials; in the presently preferred embodiment the spacer is stamped from 1020 mild steel. The method 100 also comprises steps 108, 110, and 112, respectively, for machining a bearing recess to accommodate the spacer, milling an anti-rotation groove in the surface comprising the recess, and assembling one or more shims, an anti-rotation spacer, and a bearing assembly in the bearing recess. As will be apparent to those skilled in the art, this milling operation may be replaced with various alternative operations, such as drilling, peening, and so forth, such as for field installation of an anti-rotation spacing device. The operation may also be altered depending upon the nature and physical configuration of the anti-rotation feature, such as if pins, screws, protrusions from the housing, or other structures are employed to prevent rotation of the spacing device.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A rotating machine comprising:
a housing comprising a bore configured to receive a bearing assembly;
a bearing assembly positioned within the bore, the bearing assembly comprising an inner ring, an outer ring, and a plurality of bearings, wherein the plurality of bearings bear against an inner race of the inner ring and an outer race of the outer ring;
a shim positioned within the bore; and
a spacing device interposed between the shim and the bearing assembly within the bore, the spacing device being secured from rotation with the bearing assembly to prevent damage to the shims.

2. The rotating machine of claim 1, wherein the rotating machine is a gear reducer.

3. The rotating machine of claim 1, wherein the housing comprises a generally right cylindrical bore.

4. The rotating machine of claim 1, wherein the bearing assembly comprises a plurality of tapered roller bearings.

5. The rotating machine of claim 1, wherein the spacing device comprises an anti-rotation feature.

6. The rotating machine of claim 5, wherein the anti-rotation feature is a tab extending from the spacing device.

7. The rotating machine of claim 6, wherein the housing further comprises a groove formed in a surface of the housing encompassing the bore, the groove being configured to cooperate with the tab extending from the spacing device to prevent rotation of the spacing device within the bore.

8. The rotating machine of claim 6, wherein the tab extends radially from the spacing device.

9. The rotating machine of claim 5, wherein the anti-rotation feature is a notch in an outer perimeter of the spacing device.

10. The rotating machine of claim 9, wherein the housing further comprises a ridge formed on a surface of the housing encompassing the bore, the ridge being configured to cooperate with the notch in the outer perimeter of the spacing device.

11. The rotating machine of claim 1, comprising a plurality of shims.

12. A method for preventing damage to shims proximate to a bearing assembly, the method comprising:
providing a housing of a rotating machine;
forming an anti-rotation feature on a surface adjacent to a recess in the housing; and
placing a bearing assembly, a shim, and an anti-rotation spacing device within the recess, wherein the anti-rotation spacing device is disposed between the bearing assembly and the shim and cooperates with the anti-rotation feature on the surface adjacent to the recess to prevent rotation of the anti-rotation spacing device.

13. The method of claim 12, wherein the rotating machine is a gear reducer.

14. The method of claim 12, wherein the anti-rotation feature is a groove in a surface encircling the recess.

15. The method of claim 14, wherein the anti-rotation spacing device comprises a generally annular structure and a radial extension adapted to cooperate with the groove in the surface encircling the recess to prevent rotation of the anti-rotation spacing device.

16. The method of claim 15, wherein forming the anti-rotation feature comprises milling the groove.

17. The method of claim 12, wherein the anti-rotation feature is a ridge on a surface encircling the recess.

18. The method of claim 17, wherein the anti-rotation spacing device comprises a generally annular structure having a radial indentation adapted to cooperate with the ridge on the surface encircling the recess to prevent rotation of the anti-rotation spacing device.

19. The method of claim 12, wherein the bearing assembly comprises a plurality of tapered roller bearings.

20. The method of claim 12, further comprising machining a recess in the housing of the rotating machine.

21. A method of manufacturing an anti-rotation spacing device, the method comprising:
forming an anti-rotation spacing device out of a sheet of metal, the anti-rotation spacing device comprising an anti-rotation feature, the spacing device having a front surface configured to bear against a bearing assembly and a rear surface configured to bear against a shim, the anti-rotation feature being configured to resist a moment on the spacing device imparted by the bearing assembly to prevent rotation of the spacing device with the bearing assembly; and
deburring the anti-rotation spacing device to provide smooth front and rear surfaces thereof.

22. The method of claim 21, wherein the sheet of metal comprises steel.

23. The method of claim 22, wherein the sheet of metal comprises 1020 mild steel.

24. The method of claim 21, wherein the anti-rotation feature is a tab.

25. The method of claim 21, wherein the anti-rotation feature is a notch.

26. A shim protecting anti-rotation spacing device comprising:
a generally annular body comprising an inner perimeter, an outer perimeter, a front surface and a rear surface, the front surface configured to bear against a bearing assembly and a rear surface configured to bear against a shim; and
an anti-rotation feature formed on the body, the anti-rotation feature being configured to resist a moment on the spacing device imparted by the bearing assembly to prevent rotation of the spacing device with the bearing assembly.

27. The device of claim 26, wherein the anti-rotation feature is a tab extending from the generally annular structure.

28. The device of claim 27, wherein the tab extends radially from the outer perimeter of the generally annular structure.

29. The device of claim 26, wherein the anti-rotation feature is an indentation in the generally annular structure.

30. The device of claim 29, wherein the indentation is formed radially inward in the outer perimeter of the generally annular structure.

31. The device of claim 26, wherein the device is made of metal.

32. The device of claim 31, wherein the device is made of 1020 mild steel.
